(19) United States
(12) Patent Application Publication
(10) Pub. No.: US 2018/0109552 A1
(43) Pub. Date: Apr. 19, 2018

(54) TECHNIQUES FOR MITIGATING NON-CROSS DOMAIN CODE EXECUTION VULNERABILITIES IN CELLULAR BASEBAND

(71) Applicant: QUALCOMM Incorporated, San Diego, CA (US)

(72) Inventors: Nico GOLDE, Berlin (DE); Can ACAR, San Diego, CA (US); Robert TURNER, San Diego, CA (US); Patrick STEWIN, Berlin (DE)

(21) Appl. No.: 15/293,789

(22) Filed: Oct. 14, 2016

(51) Int. Cl. H04L 29/06; H04W 4/02; H04W 12/10

(52) U.S. Cl. CPC H04L 63/1433; H04W 4/023; H04W 88/02; H04L 63/1416; H04L 63/1425; H04W 12/10

(57) ABSTRACT

Techniques for mitigating an attack on baseband on a mobile wireless device are provided. An example method according to these techniques includes detecting a network switch event in which the mobile wireless device has disconnected from a first wireless network and connected to a second wireless network, performing an integrity check on one or more components of the mobile wireless device responsive to detecting the network switch event, and performing one or more actions responsive to the integrity check indicating that the one or more components of the mobile wireless device have been modified.

### BACKGROUND

Security of the cellular baseband is important with respect to confidentiality of voice calls and data. Attestation and runtime integrity measurement can be used to mitigate attacks against a cellular system, but this approach is often impractical because continuously measuring the system incurs significant performance overhead.

Two common types of attack on mobile wireless devices are: (1) the exploitation of flaws in SMS implementation, and (2) the luring of a victim into range of an International Mobile Subscriber Identity (IMSI) catcher. An IMSI-catcher is a virtual wireless base station that poses as a base station of a legitimate mobile wireless network provider, but is instead operated by a malicious third party attempting to gain control over mobile devices that connect to the IMSI-catcher. The second type of attack can fall into two categories (1) attacks that implant additional functionality on top of the cellular baseband implementation (e.g. redirect calls for interception, exfiltrate SMS content, or otherwise subvert mobile communications) and (2) attacks that escalate access to the applications processor by leveraging further implementation flaws.

### SUMMARY

An example method for operating a mobile wireless device according to the disclosure includes detecting a network switch event in which the mobile wireless device has disconnected from a first wireless network and connected to a second wireless network, performing an integrity check on one or more components of the mobile wireless device responsive to detecting the network switch event, and performing one or more actions responsive to the integrity check indicating that the one or more components of the mobile wireless device have been modified.

Implementations of such a method can include one or more of the following features. Detecting the network switch event includes monitoring the provisioning of key material for over-the-air communications, and determining that the network switch event has occurred responsive to identifying that the key material for over-the-air communications has been provisioned. Performing the integrity check on the one or more components of the mobile wireless device responsive to detecting the network switch event includes performing the integrity check before or as a next action following a procedure to update a location of the mobile wireless device is performed by the mobile wireless device. Performing the one or more actions responsive to the integrity check indicating that the one or more components of the mobile wireless device has been modified includes rebooting the mobile wireless device to prevent an attack on the mobile wireless device. Performing the one or more actions responsive to the integrity check indicating that the one or more components of the mobile wireless device have been modified includes generating a dump of contents of volatile memory of the mobile wireless device that can be used to perform attack forensics on the mobile wireless device. Performing the integrity check on the one or more components of the mobile wireless device responsive to detecting the network switch event includes examining baseband software, hardware, or both to determine whether any changes have been made to the one or more components of the mobile wireless device.

An example mobile wireless device according to the disclosure includes a processor. The processor is configured to detect a network switch event in which the mobile wireless device has disconnected from a first wireless network and connected to a second wireless network, perform an integrity check on one or more components of the mobile wireless device responsive to detecting the network switch event, and perform one or more actions responsive to the integrity check indicating that the one or more components of the mobile wireless device have been modified.

Implementations of such a mobile wireless device can include one or more of the following features. The processor being configured to detect the network switch event is further configured to monitor the provisioning of key material for over-the-air communications, and determine that the network switch event has occurred responsive to identifying that the key material for over-the-air communications has been provisioned. The processor being configured to perform the integrity check on the one or more components of the mobile wireless device responsive to detecting the network switch event is further configured to perform the integrity check before or as a next action following a procedure to update a location of the mobile wireless device is performed by the mobile wireless device. The processor being configured to perform the one or more actions responsive to the integrity check indicating that the one or more components of the mobile wireless device has been modified is further configured to reboot the mobile wireless device to prevent an attack on the mobile wireless device. The processor being configured to perform the one or more actions responsive to the integrity check indicating that the one or more components of the mobile wireless device has been modified is further configured to generate a dump of contents of volatile memory of the mobile wireless device that can be used to perform attack forensics on the mobile wireless device. The processor being configured to perform the integrity check on the one or more components of the mobile wireless device responsive to detecting the network switch event is further configured to examine baseband software, hardware, or both to determine whether any changes have been made to the one or more components of the mobile wireless device.

An example integrated circuit for a mobile wireless device according to the disclosure includes a processor. The processor is configured to detect a network switch event in which the mobile wireless device has disconnected from a first wireless network and connected to a second wireless network, perform an integrity check on one or more components of the mobile wireless device responsive to detecting the network switch event, and perform one or more actions responsive to the integrity check indicating that the one or more components of the mobile wireless device have been modified.

Implementations of such an integrated circuit can include one or more of the following features. The processor being configured to detect the network switch event is further configured to monitor the provisioning of key material for over-the-air communications, and determine that the network switch event has occurred responsive to identifying that the key material for over-the-air communications has been provisioned. The processor being configured to perform the integrity check on the one or more components of the mobile wireless device responsive to detecting the network switch event is further configured to perform the integrity check before or as a next action following a procedure to update a location of the mobile wireless device is performed by the mobile wireless device. The processor being configured to perform the one or more actions responsive to the integrity check indicating that the one or more components of the mobile wireless device has been modified is further configured to reboot the mobile wireless device to prevent an attack on the mobile wireless device. The processor being configured to perform the one or more actions responsive to the integrity check indicating that the one or more components of the mobile wireless device has been modified is further configured to generate a dump of contents of volatile memory of the mobile wireless device that can be used to perform attack forensics on the mobile wireless device. The processor being configured to perform the integrity check on the one or more components of the mobile wireless device responsive to detecting the network switch event is further configured to examine baseband software, hardware, or both to determine whether any changes have been made to the one or more components of the mobile wireless device.

### BRIEF DESCRIPTION OF THE DRAWINGS

FIG. 1 is an example networking environment in which the techniques disclosed herein may be implemented.

FIG. 2 is a functional block diagram of an example baseband system of a mobile wireless device illustrating the technique disclosed herein.

FIG. 3 is a functional block diagram of an example computing that can be used to implement the mobile wireless device illustrated in FIGS. 1 and 2.

FIG. 4 is a flow diagram of an example process for operating a mobile wireless device according to the techniques disclosed herein.

FIG. 5 illustrates an example process for detecting a network switch event according to the techniques disclosed herein.

FIG. 6 illustrates an example process for performing an integrity check on a mobile wireless device according to the techniques disclosed herein.

FIG. 7 illustrates an example process for performing an action responsive to an integrity check indicating that one or more components of the mobile wireless device have been modified according to the techniques disclosed herein.

FIG. 8 illustrates an example process for performing an integrity check on a mobile wireless device according to the techniques disclosed herein.

FIG. 9 illustrates an example process for performing an action responsive to an integrity check indicating that one or more components of the mobile wireless device have been modified according to the techniques disclosed herein.

### DETAILED DESCRIPTION

Techniques disclosed herein for mitigating an attack on baseband on a mobile wireless device are provided. The baseband processing subsystem of a mobile wireless device can hardware and software that can be susceptible to attacks via the complex radio protocols and messages that are exchanged between the mobile wireless device and the mobile wireless network infrastructure. An attacker can exploit vulnerabilities in these radio protocols and messages to install modify data and/or program code of the baseband processing subsystem of the mobile wireless device. As discussed above, one technique that a malicious party can use to infiltrate the baseband system of the mobile wireless device is to create a fake wireless base station that appears to be a legitimate wireless base station associated with a legitimate wireless network to mislead mobile wireless devices to connect to the fake wireless base station. The fake wireless base station can then exploit the vulnerabilities of the radio protocols and messages exchanged with the mobile wireless device to infiltrate the hardware and/or software of the baseband subsystem of the mobile wireless device. The techniques disclosed herein can be used to mitigate such attacks on the baseband systems of the mobile wireless device by detecting network switch events in which the mobile wireless device disconnects from one network and connects to another and by performing integrity checks on the baseband processing subsystem and/or other components of the mobile wireless device. These techniques can be used to detect whether components of the mobile wireless device have been modified before the attacker is able to exploit the modifications to the baseband processing subsystem. The following example embodiments illustrate these concepts.

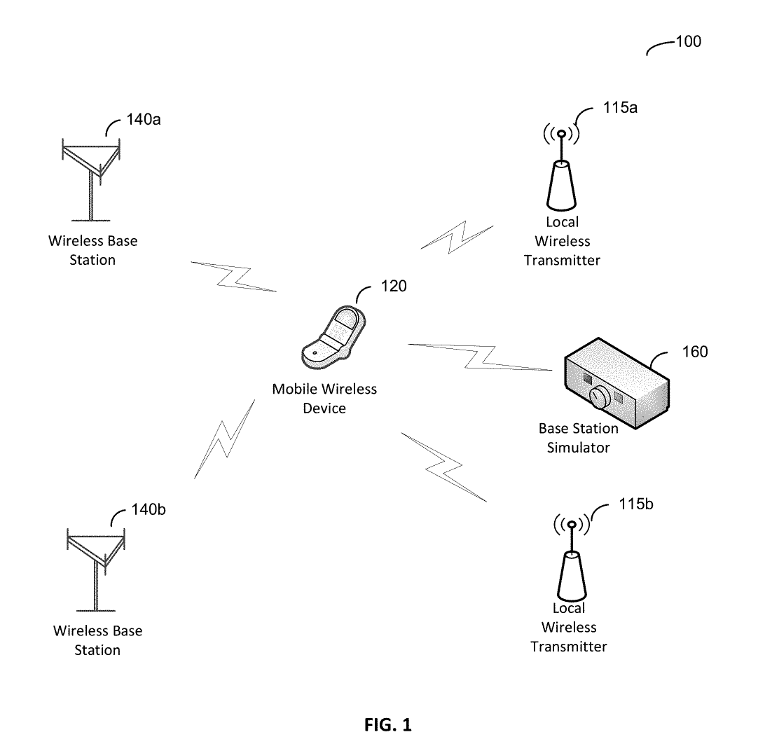

FIG. 1 is a block diagram of an example network architecture, which may be suitable for implementing the techniques discussed herein. The particular configuration illustrated herein is merely an example of one network configuration in which the techniques disclosed herein may be used. Furthermore, an implementation of such a network architecture may include additional elements that are not illustrated herein and have been omitted for the sake of clarity. The example network architecture provides an example of a network environment in which a mobile wireless device in which the techniques disclosed herein may be implemented can operate.

The mobile wireless device 120 can be a mobile communication device referred to as a User Equipment (UE), a mobile station, a terminal, an access terminal, a subscriber unit, a station, etc. The mobile wireless device 120 can be a smartphone, a tablet computer, a laptop computer, game console, wearable device (such as a smart watch) or other device that includes a wireless transmitter that is configured to communicate using one or more wireless communications protocols, including, but not limited to, the Long Term Evolution (LTE), WLAN, and WiMAX wireless communications protocols. The mobile wireless device 120 can also be configured to support other types of wireless or wired communications protocols and can be configured to support multiple different wireless communications protocols. The wireless transmitter of the mobile wireless device 120 can be configured to send data to and/or receive data from other mobile wireless devices, the wireless transmitters 115, and/or one or more wireless base stations 140.

Each of the wireless transmitters 115 can comprise a wireless local area network (WLAN) wireless access point configured to operate using the IEEE 802.11 wireless communication standards. But, in some implementations some or all of the wireless transmitters 115 may be configured to utilize other wireless communications protocols, and some network environments may include more than one type of wireless transmitter. Furthermore, while the wireless transmitters 115 are identified as transmitters, the wireless transmitters 115 may be transceivers configured to send and/or receive data wirelessly. The wireless transmitters 115 can be connected to a network via a backhaul connection that provides a broadband connection to the network. The network may be the Internet and/or a combination of one or more networks. For example, the wireless transmitter (such as one of the wireless transmitters 115) may be connected to a DSL modem or a cable modem, depending upon the type of broadband service being used in that particular implementation. A wireless transmitter (such as one of the wireless transmitters 115) can be associated with a mobile communication network provider and can be configured to communicate with the mobile communication network provider's network (not shown). The coverage area of the a wireless transmitter (such as one of the wireless transmitters 115) may overlap with that of one or more macrocell base stations, such as wireless base stations 140, or that of one or more other terrestrial transceivers.

The wireless base stations 140 can be configured to provide wireless network connectivity to a plurality of mobile wireless devices, such as mobile wireless device 120. The wireless base stations 140 can comprise a macrocell base station, a femtocell base station, a picocell base station, or other type of base station. The wireless base stations 140 may have a much larger coverage area than the wireless transmitter (such as one of the wireless transmitters 115) or may be a terrestrial transceiver that provides a coverage area that is of a similar size or of a smaller size than the coverage area provided by the wireless transmitters 115. The wireless base stations 140 can be configured to communicate using one or more wireless communications protocols. While the example illustrated in FIG. 1 includes on a single wireless base station, in other implementations the network environment is likely to include more than wireless base stations 140 which have coverage areas that may overlap at least in part.

The base station simulator 160 can comprise an IMSI-catcher or other virtual base station transceiver that poses as a legitimate wireless base station associated with a mobile wireless network provider. The base station simulator 160 can be implemented by a malicious party to lure mobile wireless devices, such as mobile wireless device 120, to connect with the base station simulator 160 instead of a legitimate wireless base station, such as one of the wireless base stations 140. The base station simulator 160 can be configured to mount attacks on the mobile wireless device 120. For example, the base station simulator 160 can be configured to implant additional functionality on the cellular baseband functionality of the mobile wireless device 120. Such an attack may be used to modify the baseband functionality of the mobile wireless device 120 to redirect calls to/from the mobile wireless device 120 for interception, to exfiltrate Short Message Service (SMS) content from the mobile wireless device 120, and/or to otherwise subvert mobile communications of the mobile wireless device 120. The techniques disclosed herein can be used to detect such attacks and to take one or more actions in response to detecting such an attack.

The example network configuration illustrated in FIG. 1 is merely an example of one possible configuration of a network in which the techniques disclosed herein may be implemented. Other network configurations may include additional elements not illustrated in FIG. 1 and the various components may be interconnected in a different configuration than what is shown in FIG. 1.

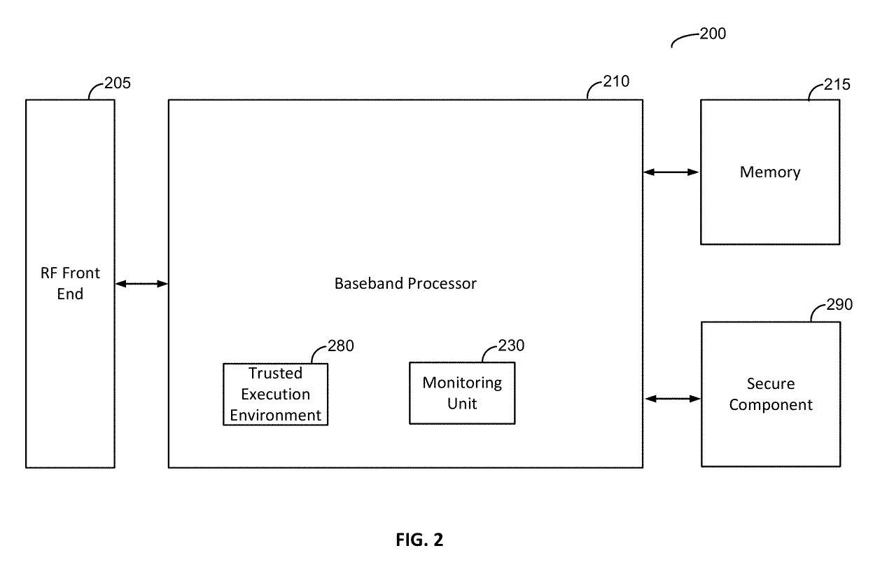

FIG. 2 is a functional block diagram of an example baseband processing subsystem 200 that can be used to perform baseband processing in a mobile wireless device, such as the mobile wireless device 120 illustrated in FIG. 1. The baseband processing subsystem 200 includes a baseband processor 210. The baseband processor 210 can be communicatively coupled to a computer-readable memory 215 that can be used to store data used by the baseband processor 210. The computer-readable memory 215 can comprise volatile memory, non-volatile memory, or a combination thereof. The baseband processor 210 of the mobile wireless device 120 can be implemented as a separate processor from a general purpose processor of the mobile wireless device (not shown) or may be implemented by the general purpose processor of the mobile wireless device. The baseband processor 210 can interface with an radio frequency (RF) front end, RF front end 205. The RF front end 205 can include one or more filters, such as bandpass filters and/or one or more amplifiers for amplifying signals to be transmitted and/or signals received by one or more antennas of the mobile wireless device 120. The baseband processor 210 can be configured to perform the various processes discussed herein for mitigating an attack on baseband on the mobile wireless device 120 disclosed herein.

The baseband processor 210 can include a trusted execution environment 280 and/or the mobile wireless device can include a secure component 290. The trusted execution environment 280 and/or the secure component 290 can be used to implement a secure processing environment for storing sensitive data and for performing processes that need to remain secure, such as the processes disclosed herein for mitigating attacks on the baseband processor. The trusted execution environment 280 can be implemented as a secure area of the baseband processor 210 that can be used to process and store sensitive data. The trusted execution environment 280 can be configured to execute trusted applications that provide end-to-end security for sensitive data by enforcing confidentiality, integrity, and protection of the sensitive data stored therein. The trusted execution environment 280 can be used to store encryption keys, secure application program code, and/or other sensitive information.

The mobile wireless device 120 can include a secure component 290 (also referred to herein as a trusted component) that can be associated with the baseband processor 210. The mobile wireless device can include the secure component 290 in addition to or instead of the trusted execution environment 280. The secure component 290 can comprise autonomous and tamper-resistant hardware that can be used to execute secure applications and/or processes. The secure component 290 can be used to implement the processes for mitigating attacks on the baseband process disclosed herein and may implement these processes in combination with the trusted execution environment 280. The secure component 290 can be configured to store sensitive data and to provide confidentiality, integrity, and protection to the data stored therein. The secure component 290 can be used to store encryption keys, user data, and/or other sensitive data. The secure component 290 can be integrated with the hardware of the mobile wireless device in a permanent or semi-permanent fashion can be used to securely store data and/or provide a secure execution environment for applications.

The baseband processing subsystem 200 can also include a monitoring unit 230 that is configured to perform the various techniques disclosed herein for mitigating an attack on baseband processing subsystem 200. The monitoring unit 230 can be implemented as a trusted application comprising program code executable by the trusted execution environment 280 and/or the secure component 290 and stored in a secure memory location associated with one or both of trusted execution environment 280 and/or the secure component 290 to prevent an attacker from tampering with or disabling the monitoring unit 230. In other implementations, the monitoring unit 230 can be implemented in hardware, such as one or more application specific integrated circuits (ASICs), programmable logic devices (PLDs), field programmable gate arrays (FPGAs), or other electronic units designed to perform the functions described herein, or a combination thereof.

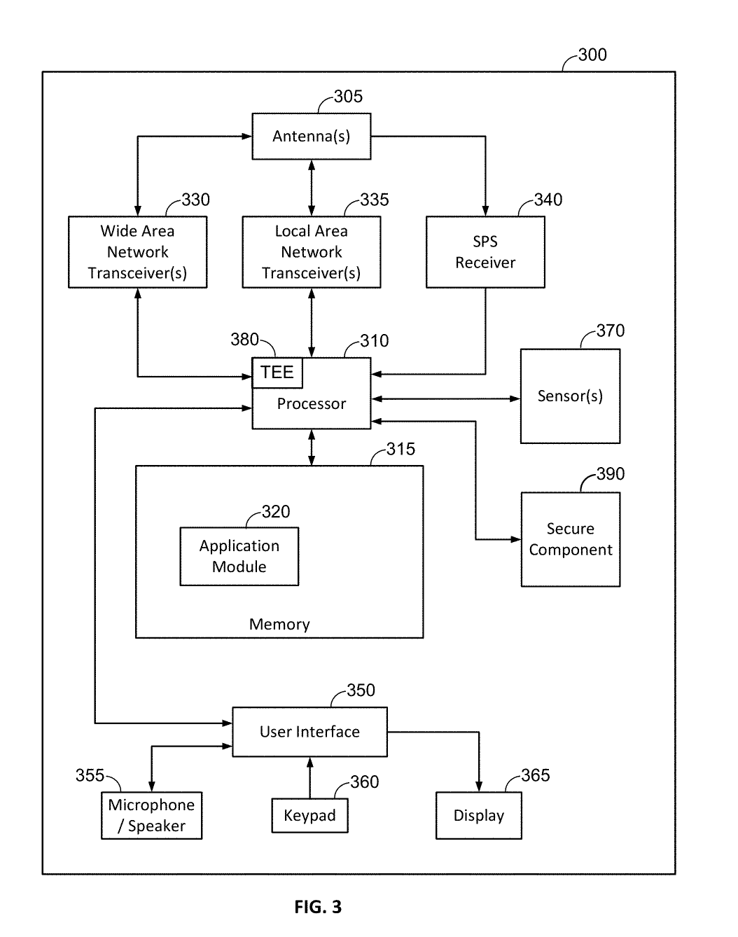

FIG. 3 is a functional block diagram of an example computing device 300 that can be used to implement the mobile wireless device 120 illustrated in FIGS. 1 and 2. FIG. 3 is a schematic diagram illustrating various components of an example computing device 300, which can be similar to or the same as the mobile wireless device 120 depicted in FIG. 1. For the sake of simplicity, the various features/components/functions illustrated in the schematic boxes of FIG. 3 are connected together using a common bus to represent that these various features/components/functions are operatively coupled together. Other connections, mechanisms, features, functions, or the like, can be provided and adapted as necessary to operatively couple and configure a portable wireless device. Furthermore, one or more of the features or functions illustrated in the example of FIG. 3 can be further subdivided, or two or more of the features or functions illustrated in FIG. 3 can be combined. Additionally, one or more of the features or functions illustrated in FIG. 3 can be excluded.

As shown, the computing device 300 can include one or more local area network transceivers 335 that can be connected to one or more antennas 305. The one or more local area network transceivers 335 comprise suitable devices, circuits, hardware, and/or software for communicating with and/or detecting signals to/from one or more of the WLAN access points, and/or directly with other wireless devices within a network. In some embodiments, the local area network transceiver(s) 335 can comprise a WiFi (802.11x) communication transceiver suitable for communicating with one or more wireless access points; however, in some embodiments, the local area network transceiver(s) 335 can be configured to communicate with other types of local area networks, personal area networks (e.g., Bluetooth® wireless technology networks), etc. Additionally, any other type of wireless networking technologies can be used, for example, Ultra Wide Band, ZigBee, wireless USB, etc.

The computing device 300 can also include, in some implementations, one or more wide area network transceiver(s) 330 that can be connected to the one or more antennas 305. The wide area network transceiver 330 can comprise suitable devices, circuits, hardware, and/or software for communicating with and/or detecting signals from one or more of, for example, the WWAN access points and/or directly with other wireless devices within a network. In some implementations, the wide area network transceiver(s) 330 can comprise a CDMA communication system suitable for communicating with a CDMA network of wireless base stations. In some implementations, the wireless communication system can comprise other types of cellular telephony networks, such as, for example, TDMA, GSM, WCDMA, LTE etc. Additionally, any other type of wireless networking technologies can be used, including, for example, WiMax (802.16), etc.

In some embodiments, an SPS receiver (also referred to as a global navigation satellite system (GNSS) receiver) 340 can also be included with the computing device 300. The SPS receiver 340 can be connected to the one or more antennas 305 for receiving satellite signals. The SPS receiver 340 can comprise any suitable hardware and/or software for receiving and processing SPS signals. The SPS receiver 340 can request information as appropriate from the other systems, and can perform the computations necessary to determine the position of the computing device 300 using, in part, measurements obtained by any suitable SPS procedure. Some implementations of the computing device 300 may not include an SPS receiver. Furthermore, while the computing device 300 may include an SPS receiver, the computing device 300 may be positioned in a location where the signals from the SPS satellites are obstructed and a time fix from the SPS system cannot be obtained in order to determine and correct for any inaccuracies in the frequency of the crystal oscillator.

As further illustrated in FIG. 3, the example computing device 300 includes one or more sensors 370 coupled to a controller/processor 310. For example, the sensors 370 can include motion sensors to provide relative movement and/or orientation information (which is independent of motion data derived from signals received by the wide area network transceiver(s) 330, the local area network transceiver(s) 335, and/or the SPS receiver 340). By way of example but not limitation, the motion sensors can include an accelerometer, a gyroscope, and a geomagnetic (magnetometer) sensor (e.g., a compass), any of which can be implemented based on micro-electro-mechanical-system (MEMS), or based on some other technology. The motion sensor can be used to identify vibrations and/or other motions that may impact the accuracy of the crystal oscillator of the computing device. The one or more sensors 370 can further include, a thermometer (e.g., a thermistor), an audio sensor (e.g., a microphone) and/or other sensors. The one or more sensors 370 can also include a camera (e.g., a charge-couple device (CCD)-type camera, a CMOS-based image sensor, etc.), which can produce still or moving images (e.g., a video sequence) that can be displayed on a user interface device, such as a display or a screen, and that can be further used to determine an ambient level of illumination and/or information related to colors and existence and levels of UV and/or infra-red illumination.

The processor(s) (also referred to as a controller) 310 can be connected to the local area network transceiver(s) 335, the wide area network transceiver(s) 330, the SPS receiver 340 and the one or more sensors 370. The processor can include one or more microprocessors, microcontrollers, and/or digital signal processors that provide processing functions, as well as other calculation and control functionality. The processor 310 can be coupled to storage media (e.g., memory) 315 for storing data and software instructions for executing programmed functionality within the mobile device. The memory 315 can be on-board the processor 310 (e.g., within the same IC package), and/or the memory can be external memory to the processor and functionally coupled over a data bus. In some implementations, the processor 310 can be used to implement the baseband processor 210 of the baseband processing subsystem 200 illustrated in FIG. 2, while in other implementations the baseband processor 210 can be implemented as a separate component of the computing device 300, and may, for example be implemented as part of the wide area network transceiver(s) 330 component of the computing device 300.

A number of software modules and data tables can reside in memory 315 and can be utilized by the processor 310 in order to manage both communications with remote devices/nodes, perform positioning determination functionality, and/or perform device control functionality. As illustrated in FIG. 3, in some embodiments, the memory 315 can include an application module 320 which can implement one or more applications. It is to be noted that the functionality of the modules and/or data structures can be combined, separated, and/or be structured in different ways depending upon the implementation of the computing device 300.

The application module 320 can be a process running on the processor 310 of the computing device 300, which can request information from the application module 316 or other data from one of the other modules of the computing device 300. Applications typically run within an upper layer of the software architectures and can be implemented in a rich execution environment of the computing device 300.

The processor 310 can include a trusted execution environment 380 and/or the computing device 300 may include a secure component 390. The trusted execution environment 380 can be used to implement the trusted execution environment 280 of the baseband processing subsystem 200 illustrated in FIG. 2 where the processor 310 implements the baseband processor 210. In implementations where the baseband processor 210 is implemented separately from the processor 310, both the baseband processor 210 and the processor 310 can implement their own trusted execution environments. Furthermore, the secure component 390 can be used to implement the secure component 290 of the baseband processing subsystem 200 illustrated in FIG. 2. The trusted execution environment 380 and/or the secure component 390 can be used to implement a secure processing environment for storing sensitive data and for performing processes that need to remain secure, such as the processes disclosed herein for mitigating attacks on the baseband processor 210.

The trusted execution environment 380 can be implemented as a secure area of the processor 310 that can be used to process and store sensitive data. The trusted execution environment 380 can be configured to execute trusted applications that provide end-to-end security for sensitive data by enforcing confidentiality, integrity, and protection of the sensitive data stored therein. The trusted execution environment 380 can be used to store encryption keys, secure application program code, and/or other sensitive information.

The computing device 300 can include a secure component 390 (also referred to herein as a trusted component). The mobile wireless device can include the secure component 390 in addition to or instead of the trusted execution environment 380. The secure component 390 can comprise autonomous and tamper-resistant hardware that can be used to execute secure applications and/or processes. The secure component 390 can be used to implement the processes for mitigating attacks on the baseband process disclosed herein and may implement these processes in combination with the trusted execution environment 380. The secure component 390 can be configured to store sensitive data and to provide confidentiality, integrity, and protection to the data stored therein. The secure component 390 can be used to store encryption keys, user data, and/or other sensitive data. The secure component 390 can be integrated with the hardware of the mobile wireless device in a permanent or semi-permanent fashion can be used to securely store data and/or provide a secure execution environment for applications.

The computing device 300 can further include a user interface 350 providing suitable interface systems, such as a microphone/speaker 355, a keypad 360, and a display 365 that allows user interaction with the computing device 300. The microphone/speaker 355 (which can be the same or different from the audio sensor) provides for voice communication services (e.g., using the wide area network transceiver(s) 330 and/or the local area network transceiver(s) 335). The keypad 360 can comprise suitable buttons for user input. The display 365 can include a suitable display, such as, for example, a backlit LCD display, and can further include a touch screen display for additional user input modes.

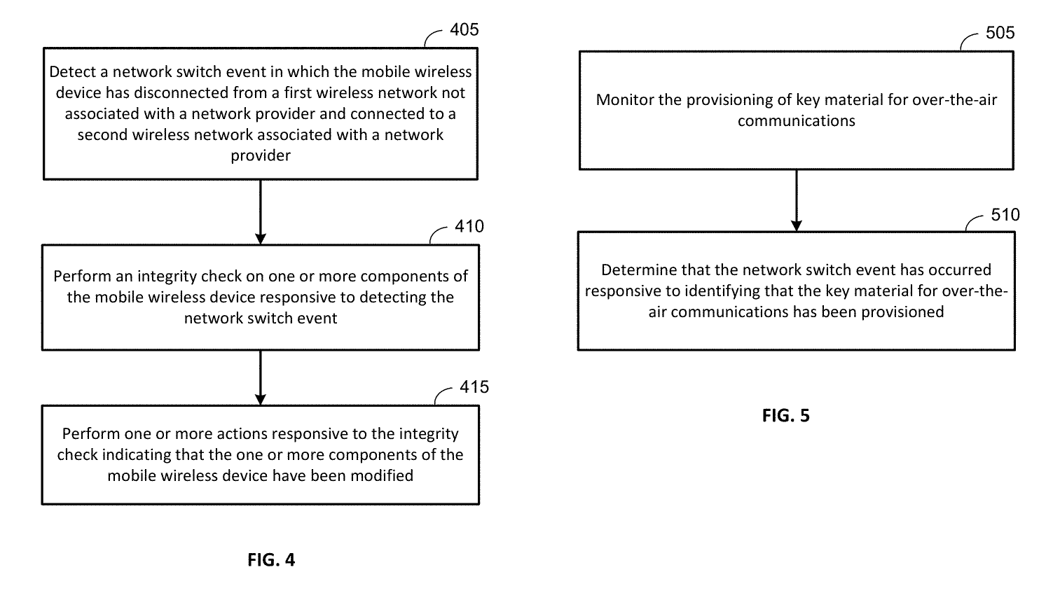

FIG. 4 is a flow diagram of an example process for operating a mobile wireless device according to the techniques disclosed herein. The process illustrated in FIG. 4 can be implemented by the monitoring unit 230 of the baseband processor 210 of the mobile wireless device 120. The process illustrated in FIG. 4 can be used to mitigate an attack on the baseband subsystem on the mobile wireless device 120.

A network switch event can be detected in which the mobile wireless device has disconnected from a first wireless network and connected to a second wireless network (stage 405). The monitoring unit 230 of the baseband processor 210 can be configured to monitor for network switch events in which the mobile wireless device 120 disconnects from a first wireless network and connects to a second wireless network. Such a switch may indicate that the mobile wireless device 120 has disconnected from a first wireless network not associated with a network provider and instead associated with a malicious network entity, such as the base station simulator 160, that was masquerading as a wireless base station of a legitimate network service provider and has now connected to a wireless network associated with a legitimate network provider. The malicious network entity may have sent a specially crafted payload to the mobile wireless device 120 that exploits flaws in the wireless protocols to introduce attacker-added functionality into the baseband processing subsystem 200 of the mobile wireless device 120, which may become active once the mobile wireless device has connected to a legitimate wireless network associated with a wireless network provider. The attacker-added functionality may have introduced functionality to redirect calls for interception, exfiltrate SMS content, otherwise subvert mobile communications once the mobile wireless device 120 has connected to a legitimate wireless network.

One or more actions can be performed responsive to the integrity check indicating that the one or more components of the mobile wireless device 120 have been modified (stage 415). The monitoring unit 230 can be configured to perform various actions in response to the integrity check indicating that one or more components of the mobile wireless device 120 have been modified. The type of actions that are performed can be dependent upon which component or components of the mobile wireless device 120 have been modified. The monitoring unit 230 can be configured to delete newly added program code or configuration files from the mobile wireless device 120. The monitoring unit 230 can be configured to replace configuration files from a backup copy stored in a secure backup copy that may be stored in a secure memory location accessible by the monitoring unit 230 or stored in an encrypted form in a shared memory that is accessible by non-trusted applications or components of the mobile wireless device 120. The monitoring unit 230 can be configured to reboot the mobile wireless device 120. The monitoring unit 230 can be configured to generate a dump of the contents of the computer-readable memory 215 and/or other volatile memory of the mobile wireless device 120. Other actions can also be taken in addition to or instead of these actions.

FIG. 5 illustrates an example process for detecting a network switch event according to the techniques disclosed herein. The process illustrated in FIG. 5 can be implemented by the baseband processor 210 of the mobile wireless device 120. The monitoring unit 230 can be used to implement the process of FIG. 5. The process illustrated in FIG. 5 can be used to implement, at least in part, stage 405 of the process illustrated in FIG. 4.

The provisioning of key materials for over-the-air communications can be monitored (stage 505). The monitoring unit 230 can be configured to monitor the provisioning of keys associated with the over-the-air communications between the mobile wireless device 120 and another network entity, such as a wireless base station of the wireless base stations 140, to determine when a network switch has occurred. Malicious program code that has been installed into the baseband subsystem by a malicious network entity, such as the base station simulator 160, may attempt to suppress the information indicative of network switch events from other components of the mobile wireless device 120, so that the user of the mobile wireless device 120 and/or other components of the mobile wireless device 120 may not be aware that the mobile wireless device 120 has switched from one network to another network. However, the provisioning of key materials required for communicating with a new network must occur in order for the mobile wireless device 120 to be able to connect with the new wireless network. Even malicious program code introduced into the baseband processing subsystem of the mobile wireless device 120 were to attempt to suppress that a network change event has or is able to occur, the malicious program code cannot suppress the provisioning of the key materials required to communication with the new wireless network. Most modern wireless communications networks use some form of encryption and/or integrity protection for the wireless communications conducted thereon. Otherwise, the mobile wireless device 120 would not be able to connect with a wireless network provided by a legitimate wireless network provider that uses encryption after being attacked by the base station simulator 160 or other malicious network entity to insert malicious program code and/or configuration information, and the malicious program code or configuration information would not be able to subvert the operation of the baseband processing subsystem to redirect calls to/from the mobile wireless device 120 for interception, to exfiltrate Short Message Service (SMS) content from the mobile wireless device 120, and/or to otherwise subvert mobile communications of the mobile wireless device 120.

A determination that a network switch event has occurred can be made responsive to identifying that the key material for the over-the-air communications has been provisioned (stage 510). monitoring unit 230 can be configured to cause the mobile wireless device 120 to make a determination that the network switch event has occurred in response to the key material being provisioned.

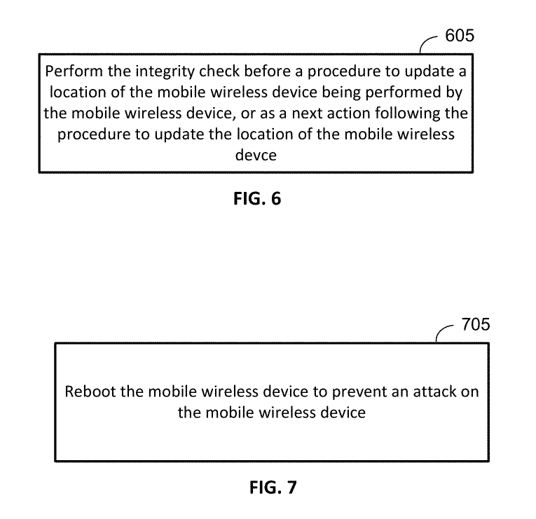

FIG. 6 illustrates an example process for performing an integrity check on a mobile wireless device according to the techniques disclosed herein. The monitoring unit 230 can be used to implement the process of FIG. 6. The process illustrated in FIG. 6 can be used to implement, at least in part, stage 410 of the process illustrated in FIG. 4.

The integrity check can be performed before or as a next action following a procedure to update the location of the mobile wireless device 120 is performed by the mobile wireless device 120 (stage 605). The mobile wireless device 120 can be configured to perform a procedure to update the location of the mobile wireless device 120 responsive to a network switch event. For example, the mobile wireless device 120 can be configured to perform a Tracking Area Update (TAU) procedure where the mobile wireless device 120 connects to an LTE-enabled wireless base station or to perform a location update procedure where the mobile wireless device 120 connects to a GSM-enabled wireless base station. Other types of location update protocols may be used depending upon the type of network to which the mobile wireless device 120 connects. The integrity check can be performed responsive to determining that a network switch event has occurred and just before or immediately after the mobile wireless device 120 updates is location in response to the network switch event. The integrity check can be performed at this point to ensure that any attacker-added functionality that may have been introduced into the baseband processing subsystem 200 as a result of connecting to the malicious network entity, such as the base station simulator 160, is identified before the mobile wireless device 120 engages in any activity over the network of the legitimate network provider. For example, the attacker may have introduced functionality to redirect calls for interception, exfiltrate SMS content, otherwise subvert mobile communications. But, the integrity check can be performed and action can be taken in response to any attacker-added functionality being detected by the integrity check before the attacker-added functionality is able to be utilized.

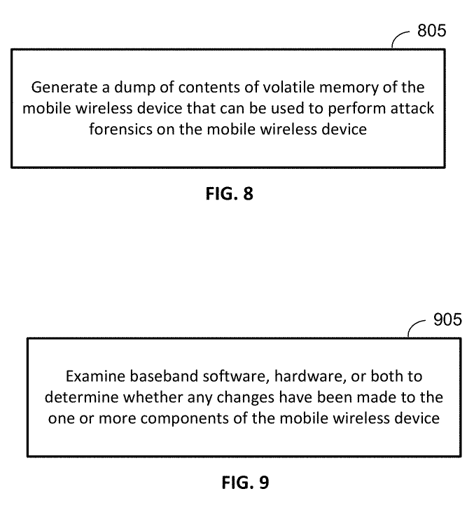

FIG. 7 illustrates an example process for performing an action responsive to an integrity check indicating that one or more components of the mobile wireless device have been modified according to the techniques disclosed herein. The monitoring unit 230 can be used to implement the process of FIG. 8. The process illustrated in FIG. 8 can be used to implement, at least in part, stage 415 of the process illustrated in FIG. 4.

The mobile wireless device 120 can be rebooted to prevent an attack on the mobile wireless device 120 (stage 705). The monitoring unit 230 can be configured to cause the mobile wireless device 120 to reboot responsive to a determination that one or more of the components of the mobile wireless device 120 have been modified. The reboot can be performed after the monitoring unit 230 has performed one or more other remedial measures in response to the determination that one or more components of the mobile wireless device 120 have been modified. For example, the monitoring unit 230 can delete or disable new or altered program code that was installed in the baseband processing subsystem of the mobile wireless device 120 by a malicious network entity, such as the base station simulator 160, in response to the mobile wireless device 120 connecting to the malicious network entity. The monitoring unit 230 can delete or restore configuration files that were installed or altered by the malicious network entity and then can reboot the mobile wireless device 120 to halt any malicious program code that may still be executing on the mobile wireless device 120.

FIG. 8 illustrates an example process for performing an action responsive to an integrity check indicating that one or more components of the mobile wireless device have been modified according to the techniques disclosed herein. The monitoring unit 230 can be used to implement the process of FIG. 8. The process illustrated in FIG. 8 can be used to implement, at least in part, stage 415 of the process illustrated in FIG. 4.

A dump of contents of the volatile memory of the mobile wireless device 120 can be performed (stage 805). The dump of the contents of the volatile memory of the mobile wireless device 120 can be used to perform attack forensics on the mobile wireless device 120. The dump of the contents of the volatile memory can be encrypted in some implementations. The dump of the contents of the volatile memory could potentially be used by an attacker to determine additional information about the mobile wireless device 120 that could potentially be used by the attacker to further compromise additional components of the mobile wireless device 120. The dump of the contents of the volatile memory can be encrypted using a private key associated with the mobile wireless device 120 that is managed by the monitoring unit 230, the trusted execution environment 280, the secure component 290 of the mobile wireless device 120, or a key management component of the mobile wireless device 120. They key can be a shared secret key that is known to manufacturer of the mobile wireless device 120, a network provider associated with the mobile wireless device 120, or other entity that is who can perform attack forensics on the mobile wireless device 120 by first decrypting the encrypted dump of the contents of the volatile memory. The dump of the contents of the volatile memory may provide information that can be used to implement changes to the hardware and/or the software of the baseband processing subsystem of the mobile wireless device 120 to prevent such attacks in the future.

FIG. 9 illustrates an example process for performing an action responsive to an integrity check indicating that one or more components of the mobile wireless device have been modified according to the techniques disclosed herein. The monitoring unit 230 can be used to implement the process of FIG. 9. The process illustrated in FIG. 9 can be used to implement, at least in part, stage 415 of the process illustrated in FIG. 4.

The baseband software, hardware, or both can be examined to determine whether any changes have been made to one or more components of the mobile wireless device 120 (stage 905). Changes to the program code and/or the configuration data of the baseband processing subsystem of the mobile wireless device 120 can be identified using an authentication tag, as discussed above. The monitoring unit 230 can also be configured to monitor for the presence of new program code and/or configuration files, and can be configured to monitor timestamps and/or files sizes associated with existing program code and/or configuration files to identify files that may have been changed by a malicious third party after the network switch occurred.

The methodologies described herein may be implemented by various means depending upon the application. For example, these methodologies may be implemented in hardware, firmware, software, or any combination thereof. For a hardware implementation, the processing units may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, electronic devices, other electronic units designed to perform the functions described herein, or a combination thereof

For a firmware and/or software implementation, the methodologies may be implemented with modules (e.g., procedures, functions, and so on) that perform the functions described herein. Any machine-readable medium tangibly embodying instructions may be used in implementing the methodologies described herein. For example, software codes may be stored in a memory and executed by a processor unit. Memory may be implemented within the processor unit or external to the processor unit. As used herein the term “memory” refers to any type of long term, short term, volatile, nonvolatile, or other memory and is not to be limited to any particular type of memory or number of memories, or type of media. Tangible media include one or more physical articles of machine readable media, such as random access memory, magnetic storage, optical storage media, and so on.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. Such media also provide examples of non-transitory media, which can be machine readable, and wherein computers are an example of a machine that can read from such non-transitory media.

The generic principles discussed herein may be applied to other implementations without departing from the spirit or scope of the disclosure or claims.

What is claimed is:

1. A method for operating a mobile wireless device, the method comprising:
detecting a network switch event in which the mobile wireless device has disconnected from a first wireless network and connected to a second wireless network;
performing an integrity check on one or more components of the mobile wireless device responsive to detecting the network switch event; and
performing one or more actions responsive to the integrity check indicating that the one or more components of the mobile wireless device have been modified.

2. The method of claim 1, wherein detecting the network switch event further comprises:
monitoring the provisioning of key material for over-the-air communications; and
determining that the network switch event has occurred responsive to identifying that the key material for over-the-air communications has been provisioned.

3. The method of claim 1, wherein performing the integrity check on the one or more components of the mobile wireless device responsive to detecting the network switch event further comprises:
performing the integrity check before or as a next action following a procedure to update a location of the mobile wireless device is performed by the mobile wireless device.

4. The method of claim 1, wherein performing the one or more actions responsive to the integrity check indicating that the one or more components of the mobile wireless device has been modified further comprises:
rebooting the mobile wireless device to prevent an attack on the mobile wireless device.

5. The method of claim 1, wherein performing the one or more actions responsive to the integrity check indicating that the one or more components of the mobile wireless device have been modified comprises:
generating a dump of contents of volatile memory of the mobile wireless device that can be used to perform attack forensics on the mobile wireless device.

6. The method of claim 1, wherein performing the integrity check on the one or more components of the mobile wireless device responsive to detecting the network switch event further comprises:
examining baseband software, hardware, or both to determine whether any changes have been made to the one or more components of the mobile wireless device.

7. A mobile wireless device comprising:
a processor configured to:
detect a network switch event in which the mobile wireless device has disconnected from a first wireless network and connected to a second wireless network;
perform an integrity check on one or more components of the mobile wireless device responsive to detecting the network switch event; and
perform one or more actions responsive to the integrity check indicating that the one or more components of the mobile wireless device have been modified.

8. The mobile wireless device of claim 7, wherein the processor being configured to detect the network switch event is further configured to:
monitor the provisioning of key material for over-the-air communications; and
determine that the network switch event has occurred responsive to identifying that the key material for over-the-air communications has been provisioned.

9. The mobile wireless device of claim 7, wherein the processor being configured to perform the integrity check on the one or more components of the mobile wireless device responsive to detecting the network switch event is further configured to:
perform the integrity check before or as a next action following a procedure to update a location of the mobile wireless device is performed by the mobile wireless device.

10. The mobile wireless device of claim 7, wherein the processor being configured to perform the one or more actions responsive to the integrity check indicating that the one or more components of the mobile wireless device has been modified is further configured to:
reboot the mobile wireless device to prevent an attack on the mobile wireless device.

11. The mobile wireless device of claim 7, wherein the processor being configured to perform the one or more actions responsive to the integrity check indicating that the one or more components of the mobile wireless device has been modified is further configured to:
generate a dump of contents of volatile memory of the mobile wireless device that can be used to perform attack forensics on the mobile wireless device.

12. The mobile wireless device of claim 7, wherein the processor being configured to perform the integrity check on the one or more components of the mobile wireless device responsive to detecting the network switch event is further configured to:
examine baseband software, hardware, or both to determine whether any changes have been made to the one or more components of the mobile wireless device.

13. An integrated circuit for a mobile wireless device, the integrated circuit comprising:
a processor configured to:
detect a network switch event in which the mobile wireless device has disconnected from a first wireless network and connected to a second wireless network;
perform an integrity check on one or more components of the mobile wireless device responsive to detecting the network switch event; and
perform one or more actions responsive to the integrity check indicating that the one or more components of the mobile wireless device have been modified.

14. The integrated circuit of claim 13, wherein the processor being configured to detect the network switch event is further configured to:
monitor the provisioning of key material for over-the-air communications; and
determine that the network switch event has occurred responsive to identifying that the key material for over-the-air communications has been provisioned.

15. The integrated circuit of claim 13, wherein the processor being configured to perform the integrity check on the one or more components of the mobile wireless device responsive to detecting the network switch event is further configured to:
perform the integrity check before or as a next action following a procedure to update a location of the mobile wireless device is performed by the mobile wireless device.

16. The integrated circuit of claim 13, wherein the processor being configured to perform the one or more actions responsive to the integrity check indicating that the one or more components of the mobile wireless device has been modified is further configured to:
reboot the mobile wireless device to prevent an attack on the mobile wireless device.

17. The integrated circuit of claim 13, wherein the processor being configured to perform the one or more actions responsive to the integrity check indicating that the one or more components of the mobile wireless device has been modified is further configured to:
generate a dump of contents of volatile memory of the mobile wireless device that can be used to perform attack forensics on the mobile wireless device.

18. The integrated circuit of claim 13, wherein the processor being configured to perform the integrity check on the one or more components of the mobile wireless device responsive to detecting the network switch event further is further configured to:
examine baseband software, hardware, or both to determine whether any changes have been made to the one or more components of the mobile wireless device.
